(19) United States
(12) Patent Application Publication
(10) Pub. No.: US 2024/0063933 A1
(43) Pub. Date: Feb. 22, 2024

(54) METHOD FOR MAINTAINING SYNCHRONIZATION ACCURACY IN NR IIOT AND USER EQUIPMENT

(71) Applicant: NEC Corporation, Minato-ku, Tokyo (JP)

(72) Inventors: Venkatarao Gonuguntla, Tokyo (JP); Hisashi Futaki, Tokyo (JP); Tetsu Ikeda, Tokyo (JP); Sadafuku Hayashi, Tokyo (JP); Manikantan Srinivasan, Tokyo (JP)

(73) Assignee: NEC Corporation, Minato-ku, Tokyo (JP)

(21) Appl. No.: 18/271,645

(22) PCT Filed: Jan. 11, 2022
(86) PCT No.: PCT/JP2022/000610

§ 371 Date: Jul. 10, 2023

(30) Foreign Application Priority Data
Jan. 15, 2021 (IN) 202111002014

(51) Int. Cl. H04J 3/06; H04W 56/00

(52) U.S. Cl. CPC H04J 3/0644; H04W 56/0045

(57) ABSTRACT

A method for maintaining finer synchronicity requirement (e.g. less than 1 μs synchronicity) between sync master clock and UE clock in NR IIOT is disclosed. The present disclosure introduces a method to apply the UE clock update depending on the UL timing advance reception time. The present disclosure also introduces a new signaling to indicate scheduling request ID for propagation delay change and based on which triggering timing advance to maintain the finer synchronicity requirement between sync master and UE clock. This disclosure also introduces a new method to compute the propagation delay change at UE, and thereby performing propagation delay compensation to maintain finer synchronicity requirement between sync master and UE clock.

### TECHNICAL FIELD

The present disclosure relates generally to wireless telecommunications, and, in particular embodiments, relates to maintaining finer synchronicity requirement between sync master clock and UE clock in New Radio Industrial Internet of Things (NR IIOT).

### BACKGROUND ART

In NR IIOT, some of the applications require tighter clock synchronization between the sync master clock and UE clock. The synchronicity requirement between sync master clock and UE clock in these applications is in the level of 1 microsecond (μs). The clock synchronicity requirement for different NR IIOT applications is described in table 1. (table 6.3.1-2 of TS 38.825-g00) [1]

| | Number of | | | | | |
|---|---|---|---|---|---|---|
| | devices in | | | | | |
| | one Com- | Synchro- | | | | |
| | muni- | nisation | | | | |
| Clock | cation | clock | | | | |
| synchro- | group for | synchro- | | | | |
| nicity | clock | nicity | | | | |
| accuracy | synchro- | require- | | | | |
| level | nisation | ment | | Service area | | Scenario |
| 1 | Up to 300 | <1 | μs | ≤ 100 × 100 | m | Motion control |
| | UEs | | | | | Control-to- |
| | | | | | | control |
| | | | | | | communication |
| | | | | | | for industrial |
| | | | | | | controller |
| 2 | Up to 10 | <10 | μs | ≤2500 | m² | High data rate |
| | UEs | | | | | video streaming |
| 3 | Up to 100 | <1 | μs | <20 | km² | Smart Grid: |
| | UEs | | | | | synchronicity |
| | | | | | | between PMUs |

From Table 1 it can be observed that, for two scenarios 1 μs synchronicity is needed for NR IIoT. This requirement means all the UE clocks in a communication group to be synchronized within the accuracy of finer synchronicity requirement (e.g. it is 1 μs or 10 us based on the application) with respect to sync master. In TSN, sync master may be TSN Grand master (TSN GM) clock. In this document, we use sync master and TSN GM clock inter-changeably.

In general, UE clock drifts over time due to UE crystal oscillator inaccuracy. Reference time information (T_Ref) using System Information Block (SIB) 9 may be transmitted periodically from gNB to correct the time drift. As shown in FIG. 1, T_Ref transmitted from gNB (at T_{BS}) will be received at UE after propagation delay (PD).

For example, 1 μs sync means two UE clocks has to be within +/−1 μs of reference time. As shown in FIG. 1, UEₘ and UEₙ which are at different distance from gNB may receive the reference time transmitted from gNB at different times. To meet the specified requirement for NR IIOT these two UEs should be within +/−1 μs accuracy from TSN GM clock.

UE clock accuracy is specified using a metric called “parts per million (ppm)”. 1 ppm means, 1 parts per million may be in error. That means for every 1 million micro seconds of clock run, clock may have drifted by 1 μs. For example, for every 1 sec UE clock run, it may have drifted by 1 μs. For a UE which is capable of 0.1 ppm accuracy, clock may drift by 1 μs for every 10 seconds.

Finer synchronicity requirement (e.g. 1 μs) between grand master clock and UE clock can be achieved provided the UE receives the reference time information before 1 μs time shift occurs. That means gNB may have to transmit reference time information either using SIB9 or RRC DLInformationTransfer message. If the reference time information is delivered using SIB9, gNB has to transmit SIB 9 at least every 5120 ms (SIB periodicity below 10000 ms as per TS 38.331).

Propagation delay (PD) for UE at a distance of 300 m from gNB is 1 μs. Since different UE in a communication group may be at different distance from a gNB, though reference time information is provided to all UEs at the same time, unless propagation delay is compensated while applying UE clock update, finer synchronicity requirement (e.g. 1 μs synchronicity) between UE clock and TSN GM clock is not possible.

In summary, finer synchronicity requirement (e.g. 1 μs) between TSN GM clock and UE clock can be achieved using Propagation Delay Compensation (PDC). Procedure/steps for UE clock update to achieve and maintain the finer synchronicity requirement using PDC is described below.
1. gNB configures UE with SSB measurement timing configuration (SMTC) and SRS configuration with parameters such as periodicity, offset and subcarrier spacing.
2. UE monitors different SSB beams and performs the beam measurements. Based on the measurement results, UE may feedback beam measurement report to gNB to assist TX beam change at gNB or change RX beam.

RX beam change:

Due to multipath environment of wireless medium/channel, the same TX beam from gNB may be received at UE in multiple spatial directions. Beam received in each spatial direction is called as one RX beam. To select a stronger RX beam UE may monitor beams in 360 degree spatial direction and select the stronger RX beam, this is called serving RX beam. UE further continues to track beams in all spatial directions for any possible stronger beam.

For the same TX beam, UE may change RX beam if there is a stronger RX beam than the serving RX beam and RX beam switching can be agnostic to gNB.

Since different TX/RX beams may have different propagation delays, change in TX/RX beam may result in change in propagation delay. Since timing advance is directly proportional to propagation delay, propagation delay change may result in timing advance change.
3. UE transmits SRS periodically according to configuration from gNB. With the help of SRS received, gNB may detect propagation delay change. If the detected propagation delay change is more than certain threshold (which is up to gNB implementation), gNB may trigger TA command to UE.
4. gNB transmits reference time information through SIB 9 message. The periodicity of SIB9 depends on gNB implementation.
5. Upon reference time information reception from the gNB, UE updates UE clock as T_{Ref}+PD+delta; where delta is difference between UE clock value at UE clock update instance and UE clock value at the timing of T_{Ref} reception. Where, PD=0.5*N_{TA}*T_{C}; and N_{TA} is TA command received from gNB and T_{C} is 0.509 ns.

From the procedure above, it can be observed that UE clock update requires reference time information and PD. Maintenance of finer synchronicity requirement depends on the accuracy of T_Ref and PD. Since T_Ref is received periodically from gNB, it can be assumed that its accuracy is within tolerable limit. However, PD may change based on other factors such as beam change or path change. Factors affecting PD change and possible problems in maintenance of 1 μs synchronicity between TSN GM and UE clock is described below.

Note: In the context of this document, the terminology “reference time information, reference time info, and reference time” are used interchangeably. Unless otherwise stated all of these terms carry the same meaning and it is the reference time information.

Note: In the context of this document, the terminology “TSN GM clock and TSN GM” are used interchangeably. Unless otherwise stated all of these terms means TSN GM clock.

Maintenance of 1 μs synchronicity requirement (e.g. 1 μs) between TSN GM clock and UE clock:

From PD=0.5*N_{TA}*T_{C}, we can observe that PD is directly proportional to timing advance (N_{TA}) command. Though PD can be computed from the TA, due to beam change, propagation delay may change and PD computed from previously received TA command may not be accurate.

Unless UE receive updated TA command from gNB upon beam change, TA may not be accurate. However, in some scenarios there may be delay in receiving TA command from gNB due to the fact that UE may not have transmitted any UL signal after beam change has occurred. In other words, whenever there is a propagation delay change at UE, TA command update from gNB may depend on Sounding Reference Signal (SRS) periodicity.

Further, beam change at UE may indirectly depend on the SSB periodicity as UE may be able to switch beams based on the measurements periodicity (which depends on SSB periodicity).

As discussed above based on the accuracy of crystal oscillator, gNB may transmit reference time information before UE clock drifts more than 1 μs.

In summary, though finer synchronicity requirement may be achieved by propagation delay compensation, maintenance of 1 μs synchronicity between TSN GM clock and UE clock may depend on SIB 9 periodicity and how quickly UE transmits SRS after beam change.

Possible problems in maintaining finer synchronicity requirement:

Since the periodicity of SRS is designed primarily for other purposes, configuring the periodicity of it specifically for maintaining 1 μs synchronicity between TSN GM and UE clock may not be always feasible. Due to this algorithm has to be designed to maintain 1 μs synchronicity in all possible configuration scenarios. To analyze further following scenarios are considered.
Scenario 1: SRS periodicity is smaller than SIB9 periodicity
Scenario 2: SRS periodicity is larger than SIB9 periodicity

To analyze the possible problems in maintaining finer synchronicity requirement for example 1 μs synchronicity, following example configurations are considered. UE clock update timeline is illustrated using these example configurations.

Note: Though some of the configuration parameters are provided to UE in slots, it is described in ms in this document.

Configuration 1:
SCS: 60 kHz;
SSB periodicity: 80 ms; and offset: 0 ms;
SRS periodicity: 80 ms; offset: 20 ms;
SIB 9 periodicity: 640 ms; offset: 50 ms;
UE clock update is illustrated in FIG. 2.

In this scenario, though there is PD change (at 640 ms), when UE received reference time information (at 690 ms), updated TA command is already received at UE before (at 670 ms) the reference time information reception. Hence, there is no problem in this scenario.

Configuration 2:
SCS: 60 kHz;
SSB periodicity: 80 ms; and offset: 0 ms;
SRS periodicity: 80 ms; offset: 20 ms;
SIB 9 periodicity: 640 ms; offset: 10 ms;
UE clock update for configuration 2 is illustrated in FIG. 3.

In the UE clock update illustration for configuration 2, PD change happened at 640 ms and last received TA was at 350 ms. Since the UE did not have accurate PD at the reference time information reception (at 650 ms), UE clock update at 650 ms may result in failure of 1 μs synchronicity.

### CITATION LIST

### Non Patent Literature

NPL 1: [1] 3GPP TR 21.905: “Vocabulary for 3GPP Specifications”. V15.0.0 (2018-03).
NPL 2: [2] 3GPP TS 38.331: “Radio Resource Control (RRC) protocol specification” V15.7.0.
NPL 3: [3] 3GPP TS 38.133: “Requirements for support of radio resource management”
NPL 4: [4] 3GPP TS 38.211: “Physical channels and modulation” V15.7.0
NPL 5: [5] 3GPP TS 38.212: “Multiplexing and channel coding” V15.7.0
NPL 6: [6] 3GPP TS 38.213: “Physical layer procedures for control” V15.7.0
NPL 7: [7] 3GPP TS 38.214: “Physical layer procedures for data” V15.7.0
NPL 8: [8] 3GPP TS 38.321: “Medium Access Control (MAC) protocol specification” V15.7.0
NPL 9: [9] 5G NR: “The next generation wireless technology” Eric Dahlman, Stefan Parkvall, Johan Skold

### PATENT LITERATURE

PL 1: [10] EP2829099A1 Transmission point selection

### SUMMARY OF INVENTION

### Technical Problem

In NR IIOT, some applications need to maintain finer synchronicity requirement between UEs in a communication group. In other words, TSN GM clock and all UE clocks in a communication group has to be in +/−x us (e.g. x=1) synchronization accuracy. To achieve this, reference time (T_Ref) of TSN GM clock has to be broadcasted to all UEs in a communication group.

Propagation delay (PD) for UE at a distance of 300 m from gNB is 1 μs. Since different UE in a communication group may be at different distance from a gNB, unless propagation delay is compensated when applying the reference time information received, finer synchronicity requirement between UE clock and TSN GM clock is not possible.

One agreed method for propagation delay computation for propagation delay compensation is using TA command.

UE clock may drift due to crystal oscillator inaccuracy. Propagation delay may change due to time varying nature of wireless channel. Due to these two aspects maintenance of finer synchronicity requirement is challenging.

When UE receive T_Ref from gNB to apply UE clock update, in some scenarios there may be a PD change and UE may or may not have accurate PD value depending on whether latest TA command corresponding to PD change is received or not. Unless accurate PD value is applied for propagation delay compensation of UE clock update, finer synchronicity requirement may not be maintainable for NR IIOT applications.

### Solution to Problem

The present disclosure provides an improved system and method of synchronizing clocks. More specifically, the disclosure relates to a method for maintaining 1 μs synchronization accuracy in NR IIOT.

Accordingly, the present invention in one aspect provides a method for maintaining finer synchronicity requirement (e.g. 1 μs or 10 μs) between Time-Sensitive Networking Grand Mater (TSN GM) clock and a UE clock in a User Equipment. A reference time information (T_Ref) and a Timing Advance (TA) command is received from a (R)AN node and a Propagation Delay (PD) is calculated from the TA command. UE clock update is applied wherein if PD change is not detected after the TA command reception and before the reference time information reception, the UE clock update is applied at the reference time information reception. If the PD change is detected and an updated TA command is not received after the TA command reception and before the reference time information reception, the UE clock update is applied when the updated TA command is received.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope.

The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates a related timing relation between different nodes in a communication group;

FIG. 2 illustrates a related UE clock update timeline for example configuration 1 (SRS periodicity is smaller than Reference time information periodicity);

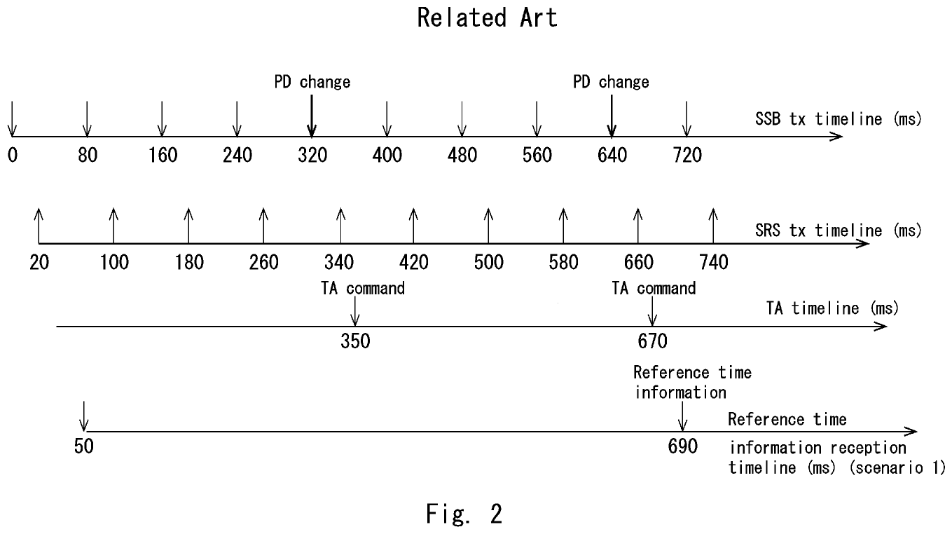

FIG. 3 illustrates a related UE clock update timeline for example configuration 2 (SRS periodicity is smaller than Reference time information periodicity);

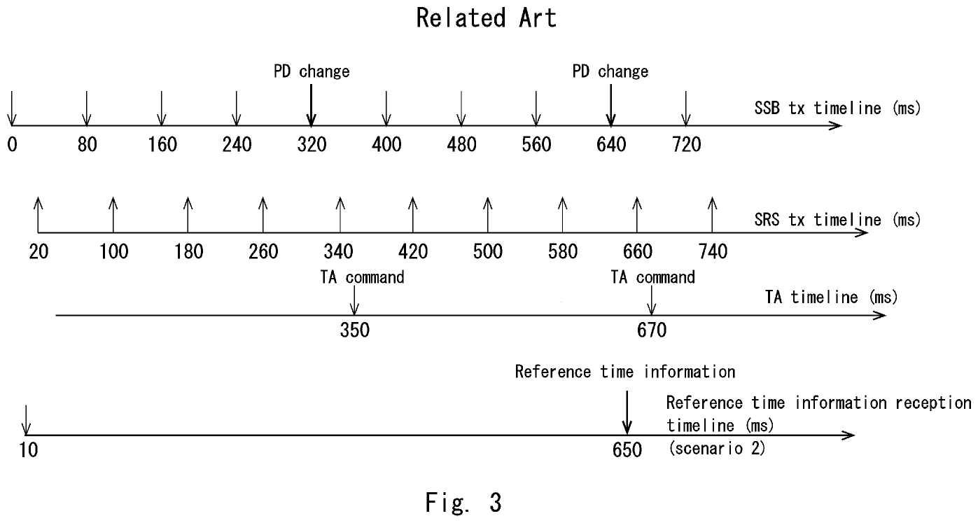

FIG. 4 is a signaling diagram illustrating an embodiment of maintaining finer synchronicity requirement between TSN GM clock and UE clock;

FIG. 5 illustrates a UE clock update timeline for example configuration;

FIG. 6 is a signaling diagram illustrating another embodiment of maintaining finer synchronicity requirement between TSN GM clock and UE clock;

FIG. 7 represents IE of SchedulingRequestResourceId;

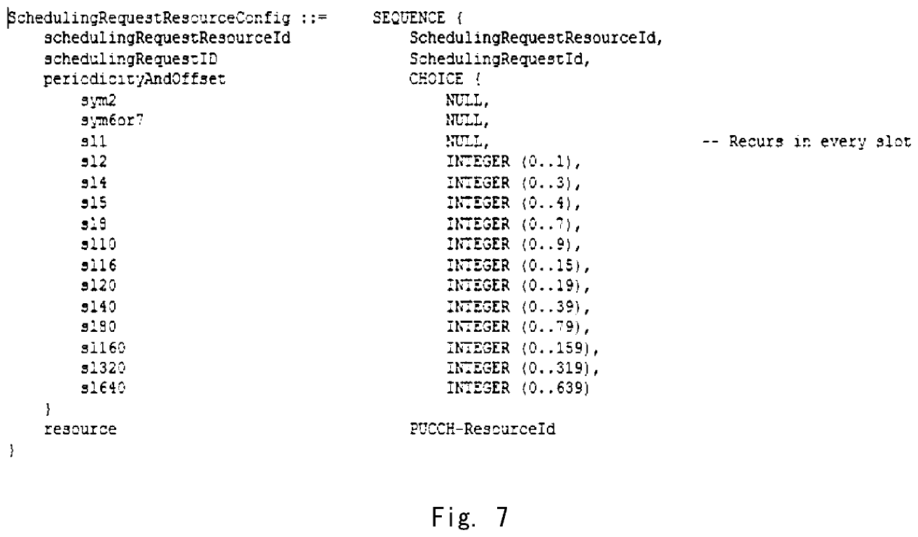

FIG. 8 is a signaling diagram illustrating yet another embodiment of maintaining finer synchronicity requirement between TSN GM clock and UE clock;

FIG. 9 is a block diagram schematically illustrating UE;

FIG. 10 is a block diagram schematically illustrating RAN node;

FIG. 11 is a block diagram schematically illustrating core network node.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DESCRIPTION OF EMBODIMENTS

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals in claims illustrate only typical embodiments of the present subject matter, and are therefore, not to be considered for limiting of its scope, for the subject matter may admit to other equally effective embodiments.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

### First Embodiment

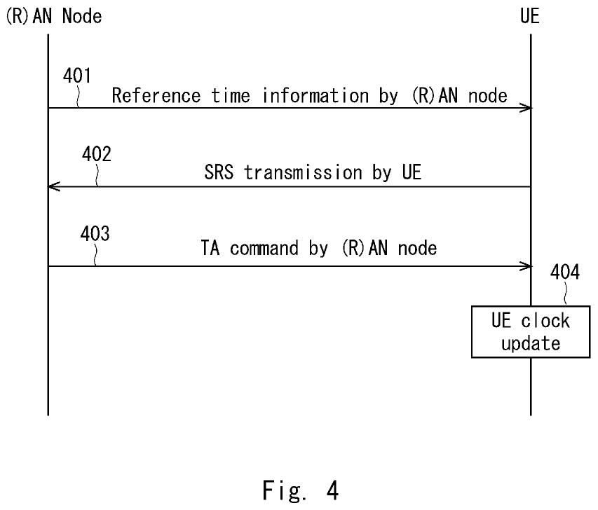

First embodiment describes a new method to maintain finer synchronicity requirement (for example, less than 1 μs synchronicity) between TSN GM clock and UE clock to solve the problem statement 1. Outline of the solution steps is shown in FIG. 4 and also described below.
401. Reference time information by (R)AN node or gNB
402. SRS transmission by UE
403. TA command by (R)AN node or gNB
404. UE clock update

The first embodiment is described as first example below.
1. In step 401, the reference time information (T_Ref) is received at the UE from the gNB. The reference time information may be transmitted through SIB 9 periodically or through RRC signaling using RRC DLInformationTransfer message. Periodicity of the SIB 9 depends on the gNB implementation.

Though the reference time information was received at the UE in step 401, since the UE may or may not know accurate PD, UE clock update may not be immediately applied at the UE after reception of the reference time information.
2. In step 402, SRS is transmitted from the UE as per the SRS configuration received from the gNB.
3. In step 403, upon reception of the SRS from the UE, the gNB may detect PD change from the SRS. If the PD change detected is more than certain threshold (which is up to the gNB implementation), the gNB may trigger TA command to the UE. The gNB may not transmit the TA command for every SRS transmission.

The SRS transmission which may trigger the TA command from the gNB may depend on the PD change and the gNB implementation.
4. In step 404, from the TA command received in step 403, the UE computes PD from the TA command. The PD computed is equal to half of TA value. The UE applies the UE clock update based on following principle.
a. If the PD change is not detected after the TA command reception and before reception of the reference time information, the UE applies the UE clock update at reception of the reference time information.
b. If the PD change is detected and updated TA command is not received after the TA command reception and before reception of the reference time information, the UE applies the UE clock update when the updated TA command is received. In other words, UE may wait for the updated TA command reception.

Further, when the UE receives the updated TA command, the UE updates its clock with T_Ref+PD+delta; where the delta is difference between UE clock value at the UE clock update and the UE clock value at the reference time information reception.

In addition, the UE may detect the PD change based on detection of beam change or path change and the PD change is computed as difference between UE DL timing at the beam change or the path change and the UE DL timing at the TA command reception.

The first embodiment is described as second example below.
1. In step 401, as explained in the first example of this embodiment, the UE receives reference time information through SIB 9 periodically or through RRC signaling using RRC DLInformationTransfer message.

Apart from receiving the reference time information, the UE also receives RRC reconfiguration message from the gNB. Through the RRC reconfiguration message, the gNB provides the UE with SSB measurement timing configuration (SMTC) and SRS configuration with parameters such as periodicity, offset and subcarrier spacing. The gNB transmits SSB signals as per the configured configuration.

As per the RRC reconfiguration message received, the UE monitors different SSB beams and performs beam measurements. Based on measurement results of the beam measurements, the UE may feedback beam measurement report to the gNB to assist TX beam change at the gNB. Due to multipath environment of wireless medium/channel, the same TX beam from the gNB may be received at the UE in multiple spatial directions. Beam received in each spatial direction is called as one RX beam. To select a stronger RX beam the UE may monitor beams in 360 degree spatial direction and select the stronger RX beam, this is called serving RX beam. UE further continues to track beams in all spatial directions for any possible stronger beam. For the same TX beam, the UE may change RX beam if there is a stronger RX beam than the serving RX beam and RX beam switching can be agnostic to gNB. Since different TX/RX beams may have different propagation delays, change in the TX/RX beam may result in the PD change. Since timing advance is directly proportional to propagation delay, the PD change may result in timing advance change.
2. In step 402, the UE transmits SRS as per the SRS configuration received in step 401.
3. In step 403, upon reception of the SRS from the UE, the gNB may detect the PD change from the SRS. If the PD change detected is more than certain threshold (which is up to gNB implementation), the gNB may trigger TA command to UE. The gNB may not transmit the TA command for every SRS transmission. The SRS transmission which may trigger the TA command from the gNB may depend on the PD change and gNB implementation.
4. In step 404, from the TA command received in step 403, UE computes latest PD. The UE applies the UE clock update based on following principle.
a. If the PD change is not detected after the TA command reception and before reception of the reference time information, the UE applies the UE clock update at reception of the reference time information.
b. If the PD change is detected and updated TA command is not received after the TA command reception and before reception of the reference time information, the UE updates its clock when the updated TA command is received. In other words, UE may wait for the updated TA command.

Further, when the UE receives the updated TA command, the UE updates its clock with T_Ref+PD+delta; where the delta is difference between UE clock value at the UE clock update and the UE clock value at the reference time information reception.

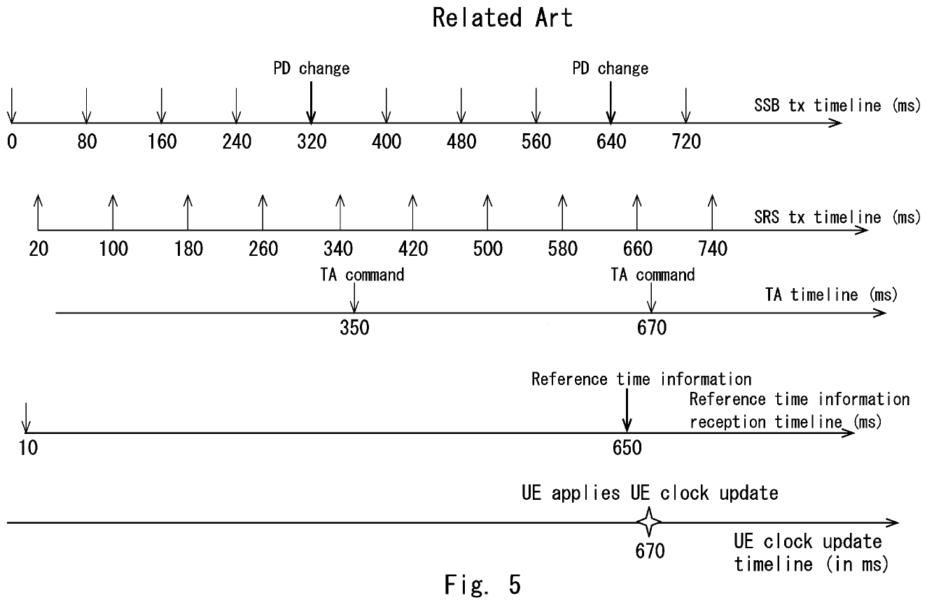

The first embodiment is described using an example configuration below. It is also illustrated in FIG. 5.

### Example Configuration

SCS: 60 kHz;
SSB periodicity: 80 ms; and offset: Oms;
SRS periodicity: 80 ms; offset: 20 ms;
SIB 9 periodicity: 640 ms; offset: 10;

In this example the gNB transmits SSB at every 80 ms. As per the configuration, the UE monitors SSB beam at every 80 ms and performs beam management. Whenever there is a strong RX beam than the serving TX beam UE performs beam switch. In the figure RX beam switch instance is shown with dark red color.

In this example, the UE transmits SRS with periodicity of 80 ms. Upon SRS reception from the UE, the gNB estimates the PD change. If the PD change is more than a certain threshold, the gNB transmits TA command to UE.

As shown in FIG. 5, there is a PD change at 320 ms and 640 ms followed by a SRS transmission after the PD change at 340 ms and 660 ms. Due to The PD change at 320 and 640 ms, may be agnostic to the gNB. The gNB may be able to detect PD change using the SRS transmitted at 340 and 660 ms. If the gNB detected PD change using the SRS, it may trigger a TA command at 350 and 670 ms.

With the SIB9 periodicity of 640 ms and offset of 10 ms, gNB transmits SIB9 at 10 ms and 650 ms. As shown in FIG. 5, PD change happened at 640 ms and last received TA is at 350 ms. If UE clock is updated at 640 ms with the PD computed from last received TA command (at 350 ms), UE PD may not be accurate and may result in failure of 1 μs synchronicity. To avoid this, the UE clock update is applied when the updated TA command is received. In this example, though reference time information is received at 650 m, since the PD change is detected at 640 ms, the UE clock is updated at 670 ms, after receiving the updated TA command.

### Second Embodiment

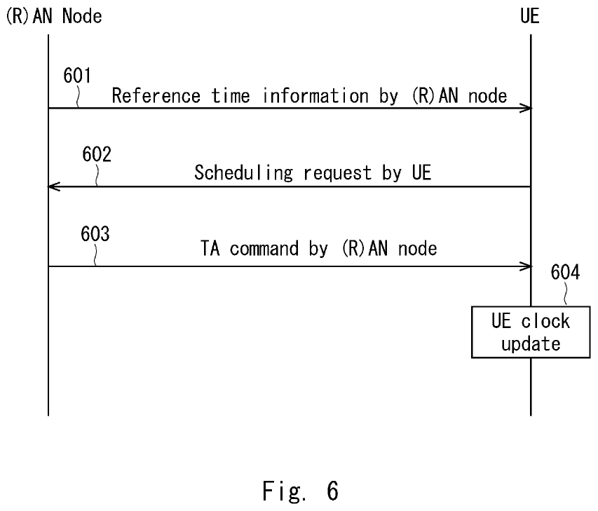

Second embodiment describes a new UE assisted and gNB based method to maintain finer synchronicity requirement (for example, less than 1 μs synchronicity) between GM clock and UE clock to solve the problem statement 1. Outline of the solution steps is shown in FIG. 6 and also described below.
601. Reference time information by (R)AN node or gNB
602. Scheduling request by UE
603. TA command by (R)AN node or gNB
604. UE clock update

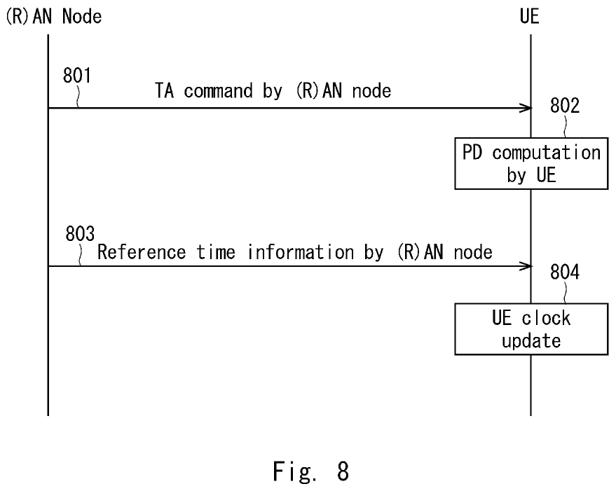

For some scenarios, the second embodiment is described below as first example.
1. In step 601, UE receives reference time information from RAN node. The reference time information may be received through SIB9 or RRC DLInformationTransfer message.
2. In step 602, when PD change is detected at the UE due to RX beam change or path change or any other reason, and there is no SRS resource available within a certain period of time or TA command is not received within the certain period of time at the UE after SRS transmission, then the UE transmits the scheduling request to indicate the PD change to the gNB. When the UE is waiting for TA command after the PD change, the UE do not apply UE clock update though the reference time information is received by the UE. The scheduling request procedure to indicate the PD change is performed as described below.
a. In this method, when the PD change is detected, the UE transmits the scheduling request (using new scheduling request ID) to indicate the PD change to the gNB. When the gNB detects new scheduling request ID, the gNB determines the purpose of the scheduling request as the PD change from the scheduling requested ID.
b. The scheduling request is transmitted following existing procedure specified in TS 38.213.
c. In this method, new type of SchedulingRequestResourceId called schedulingRequestIDForPropDelayChange, is introduced to SchedulingRequestResourceConfig IE of TS 38.331, to indicate PD change at the UE due to RX beam change, path change or any other reason. IE is provided in FIG. 8.

Where the IE SchedulingRequestResourceId is an integer and each of the SchedulingRequestResourceId ID is used to identify scheduling request resources on PUCCH for different purposes. For example, SchedulingRequestResourceId=1 may indicate purpose as purpose #1 (for example purpose #1 is the request for uplink grant. In this case SchedulingRequestResourceId=1 indicate purpose of scheduling request as request for UL grant) and SchedulingRequestResourceId=5 may indicate purpose as purpose #2 (for example purpose #2 is the PD change indication. In this case SchedulingRequestResourceId=5 indicate purpose of scheduling request as PD change), and so on. This mapping of the SchedulingRequestResourceId and purpose for which it is used is configurable implicitly or explicitly and be known both the gNB and the UE. Based on the purpose for which the UE triggered scheduling request to the gNB, the UE transmits scheduling request using the SchedulingRequestResourceId. When the gNB detects the SchedulingRequestResourceId, the gNB determines the purpose based on the SchedulingRequestResourceId.
d. The UE may be configured with a PUCCH resource by the schedulingRequestResourceId or the schedulingRequestIDForPropDelayChange to indicate the gNB about the PD change. Where the IE SchedulingRequestResourceId or the IE schedulingRequestIDForPropDelayChange is used to identify scheduling request resources on PUCCH configured for PD change indication.
e. The UE can be configured with the schedulingRequestIDForPropDelayChange using either PUCCH format 0/PUCCH format 1.

Based on the reference time information reception periodicity and channel conditions change, in some scenarios the UE may receive the reference time information before the scheduling request transmission by the UE and in some other scenarios the UE may transmit the scheduling request earlier compared to reception of the reference time information. The scheduling request transmission from the UE to indicate PD change may depend on beam change or path change. Further the PD change is computed as difference between UE DL timing at the beam change or the path change and the UE DL timing at TA command reception (last TA command before the beam change or path change).
3. In step 603, the gNB detects the scheduling request transmitted by the UE. From the scheduling request resource configuration, the gNB knows about the particular PUCCH-ResourceId configured for the schedulingRequestIDForPropDelayChange. When the gNB detects the particular PUCCH resource id, the gNB can know about PD change. If the gNB can detect the timing change from the scheduling request received, the gNB transmits TA command.
4. In step 604, upon receiving the TA command, the UE computes PD from the TA command. The PD computed is equal to half of TA value, and:
   If the UE has received reference time information (T_Ref) from the gNB when the TA command is received, the UE applies UE clock update as T_Ref+PD+delta; where the delta is difference between UE clock value at UE clock update and the UE clock value at the reference time information reception.
   If the UE receives the reference time information after transmitting the schedulingRequestIDForPropDelayChange and before receiving the updated TA command, the UE applies the UE clock update when the updated TA command is received.
   If the UE did not receive the reference time information by the time the UE receives the updated TA command, the UE updates the PD based the updated TA command and applies the UE clock update when the reference time information is received from the gNB.

In some scenarios, the gNB may not be able to detect the PD change or timing change from the scheduling request. Solution for those scenarios, is described below as second example.
1. In step 601, the UE receives reference time information from the RAN node or gNB. The reference time information may be received through SIB9 or RRC DLInformationTransfer message.
2. In step 602, the UE transmit scheduling request as per the procedure described in the step 2 of the first example of second embodiment.
3. In step 603, the gNB detects the scheduling request transmitted by the UE. Though the scheduling request is detected by the gNB, the gNB may not be able to detect the PD change or timing change from the scheduling request. In these scenarios, the gNB schedules aperiodic SRS to the UE to estimate the TA change.
4. In step 604, the UE transmits SRS transmission in the time slot scheduled using SRS resources received in aperiodic SRS scheduling grant.

If the gNB is able to detect the PD change from the SRS transmission, and the PD change is more than a threshold (threshold value may be gNB implementation), the gNB transmits TA command to the UE. Upon receiving the TA command, the UE compute PD, and:
If the UE has received the reference time information (T_Ref) from the gNB when the TA command is received, the UE applies UE clock update as T_Ref+PD+delta; where the delta is difference between UE clock value at the UE clock update and the UE clock value at the reference time information reception; and PD is the updated TA command received.
If the UE receives the reference time information after sending schedulingRequestIDForPropDelayChange and before receiving the updated TA command, the UE applies the UE clock update when the updated TA command is received.
If the UE does not receive the reference time information by the time the UE receives the updated TA command, the UE updates the PD and applies the UE clock update when the reference time information is received.

### Third Embodiment

Third embodiment describes a new UE based method, where UE computes propagation delay (PD) based on the last TA received without waiting for updated TA command from gNB to maintain finer synchronicity requirement (for example, less than 1 μs synchronicity) between GM clock and UE clock to solve the problem statement 1. Outline of the solution steps is shown in FIG. 8 and also described below.
801. TA command by (R)AN node
802. PD computation by UE
803. Reference time information by (R)AN node or gNB
804. UE clock update

Detailed flow of the solution is described below.
1. In step 801, gNB transmits TA command whenever the gNB detects PD change or timing change due to beam change or any other reason.
2. In step 802, the UE computes propagation delay (PD) by computing propagation delay difference with respect to serving beam.

The computation of PD is described using an example below.

In this example, if we assume beam X as serving beam, it's PD can be represented by PD_{beamX}=0.5*N_{TA}*T_{C}; Where N_{TA} is the latest TA command corresponding to serving beam X. PD for beam Y can be computed as PD_{beamY}=PD_{beamX}+T_{path_diff_beamY}; Where T_{path_diff_beamY} is propagation delay difference between RX beam Y and RX beam X (serving beam).

Since UE may have to measure different RX beams in different spatial direction during each SMTC duration, UE may measure only in a certain spatial direction/RX beam. Whenever UE measures in one RX beam direction, it can compute timing in that direction. Next instant when UE measures timing in that direction may be after 8*SMTC period (assuming UE measures in 8 separate spatial directions).

Due to varying channel conditions UE may perform RX beam switch to certain RX beam before that particular RX beam is measured again, it is necessary to have a method to know the path difference of the certain RX beam at any time.

One method to know the near accurate path difference for an RX beam w.r.t serving beam at any point is, having the weighted average of the path difference for all RX beams w.r.t to serving beam for which TA command is received. This can be achieved by forward computing the path difference for an RX beam when the UE measures in the certain RX beam direction and stores it. Since it is forward computed, and PD may have changed a bit compared to the time it was last measured, hence it may be helpful to take a weighted average to nullify any false deviations from the actual path difference.

Weighted average of forward computed path difference of beam Y at time t is given by T′_{path_diff_beamY}(t); which can be computed as:
T′_{path_diff_beamY}=T_{path_diff_beamY}; for first sample of path difference computation;
Else: T′_{path_diff_beamY}(t)=δ*T′_{path_diff_beamY}(t−N*8)+(1−δ)*T_{path_diff_beamY}(t);
Where N is SSB periodicity;
Note: When any of beam is not detectable, UE resets the path difference computation w.r.t that beam and restart the path difference computation when the beam is detectable again.

Weighted average may be used as an optional feature based on the scenario/application.
3. In step 803, reference time information is transmitted by gNB and received by UE.
4. In step 804, when the UE receives the reference time information (T_Ref) from the gNB, the applies UE clock update with T_Ref+PD+delta; where the delta is difference between UE clock value at the UE clock update and the UE clock value at the reference time information reception and the PD computed in the step 802 is applied here.

User equipment (UE)

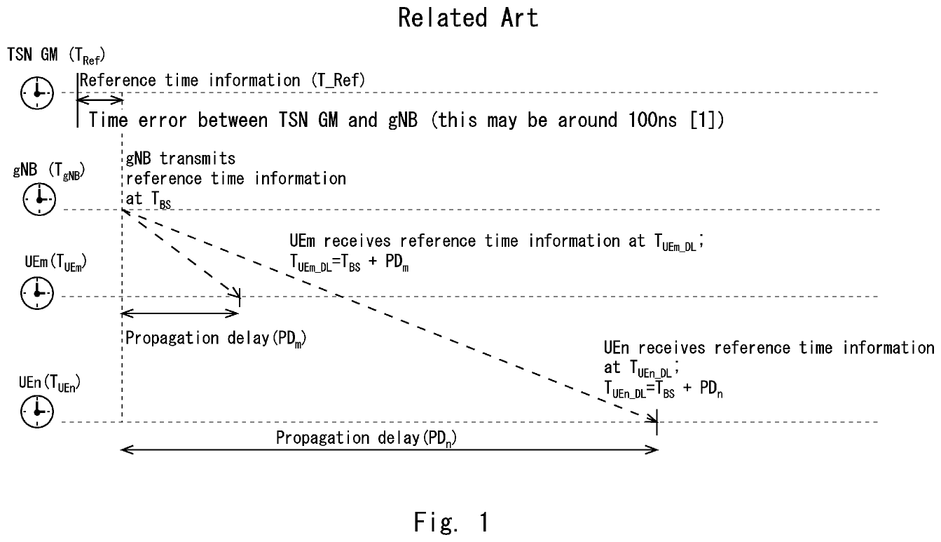

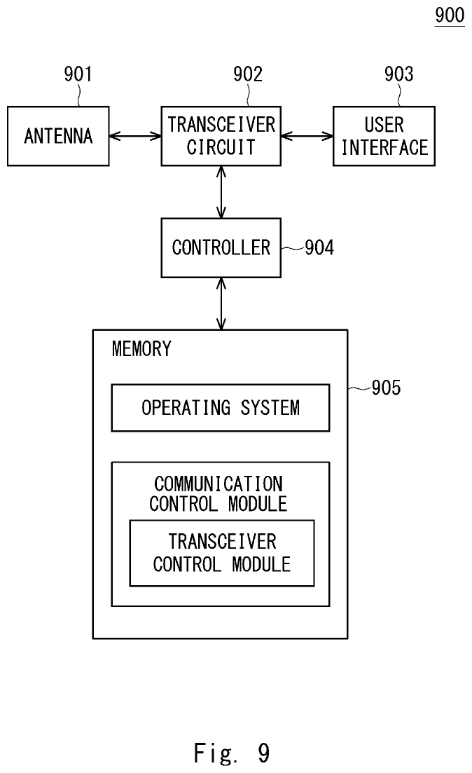

FIG. 9 is a block diagram illustrating the main components of the UE (900). As shown, the UE (900) includes a transceiver circuit (902) which is operable to transmit signals to and to receive signals from the connected node(s) via one or more antenna (901). Although not necessarily shown in FIG. 1, the UE (900) will of course have all the usual functionality of a conventional mobile device (such as a user interface) and this may be provided by any one or any combination of hardware, software and firmware, as appropriate. Software may be pre-installed in the memory and/or may be downloaded via the telecommunication network or from a removable data storage device (RMD), for example.

A controller (904) controls the operation of the UE (900) in accordance with software stored in a memory (905). For example, the controller may be realized by Central Processing Unit (CPU). The software includes, among other things, an operating system and a communications control module having at least a transceiver control module. The communications control module (using its transceiver control sub-module) is responsible for handling (generating/sending/receiving) signalling and uplink/downlink data packets between the UE and other nodes, such as the base station/(R)AN node, a MME, the AMF (and other core network nodes). Such signalling may include, for example, appropriately formatted signalling messages relating to connection establishment and maintenance (e.g. RRC messages), NAS messages such as periodic location update related messages (e.g. tracking area update, paging area updates, location area update) etc.

(R)AN node

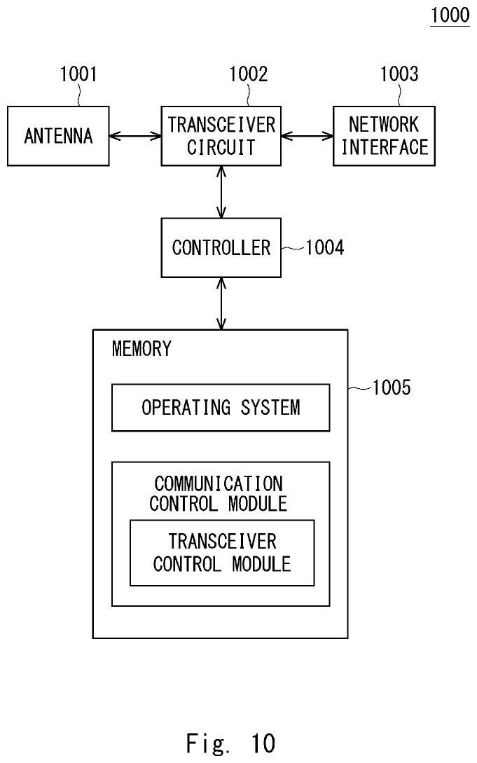

FIG. 10 is a block diagram illustrating the main components of an exemplary (R)AN node (1000), for example a base station (‘eNB’ in LTE, ‘gNB’ in 5G). As shown, the (R)AN node (1000) includes a transceiver circuit (1002) which is operable to transmit signals to and to receive signals from connected UE(s) via one or more antenna (1001) and to transmit signals to and to receive signals from other network nodes (either directly or indirectly) via a network interface (1003). A controller (1004) controls the operation of the (R)AN node (1000) in accordance with software stored in a memory (1005). For example, the controller (1004) may be realized by Central Processing Unit (CPU). Software may be pre-installed in the memory (1005) and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the (R)AN node and other nodes, such as the UE, the MME, the AMF (e.g. directly or indirectly). The signalling may include, for example, appropriately formatted signalling messages relating to a radio connection and location procedures (for a particular UE), and in particular, relating to connection establishment and maintenance (e.g. RRC connection establishment and other RRC messages), periodic location update related messages (e.g. tracking area update, paging area updates, location area update), S1 AP messages and NG AP messages (i.e. messages by N2 reference point), etc. Such signalling may also include, for example, broadcast information (e.g. Master Information and System information) in a sending case.

The controller (1004) is also configured (by software or hardware) to handle related tasks such as, when implemented, UE mobility estimate and/or moving trajectory estimation.

Core Network Node

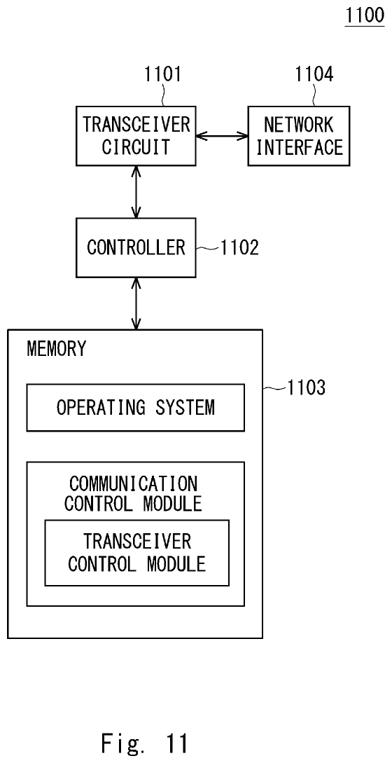

FIG. 11 is a block diagram illustrating the main components of an exemplary core network node (1100), for example an AMF, a SMF, a SEAF, an AUSF, an UPF, an UDM, an ARPF or any other core network node. The core network node (1100) is included in the 5GC. As shown, the core network node includes a transceiver circuit (1101) which is operable to transmit signals to and to receive signals from other nodes (including the UE) via a network interface (1104). A controller (1102) controls the operation of the core network node (1100) in accordance with software stored in a memory (1103). For example, the controller (1102) may be realized by Central Processing Unit (CPU). Software may be pre-installed in the memory (1103) and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the core network node and other nodes, such as the UE, base station/(R)AN node (e.g. “gNB” or “eNB”) (directly or indirectly). Such signalling may include, for example, appropriately formatted signalling messages relating to the procedures described herein, for example, NG AP message (i.e. a message by N2 reference point) to convey an NAS message from and to the UE, etc.

The User Equipment (or “UE”, “mobile station”, “mobile device” or “wireless device”) in the present disclosure is an entity connected to a network via a wireless interface.

It should be noted that the UE in this specification is not limited to a dedicated communication device, and can be applied to any device, having a communication function as a UE described in this specification, as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery.

It will be appreciated that the terms “UE” and “wireless device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine-type communication applications.

TABLE 2
Some examples of machine-type communication applications.

| Service Arca | MTC applications |
|---|---|
| Security | Surveillance systems |
| | Backup for landline |
| | Control of physical access (e.g. to |
| | buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

For example, the whole or part of the exemplary embodiments disclosed above can be described as, but not limited to, the following supplementary notes.

(Supplementary note 1)

A method implemented in a User Equipment (UE) for maintaining less than 1 microsecond synchronicity between Time-Sensitive Networking Grand Mater (TSN GM) clock and a UE clock, the method comprising:
receiving a reference time information (T_Ref) from a (R)AN node;
receiving a Timing Advance (TA) command from the (R)AN node;
computing Propagation Delay (PD) from the TA command; and
applying UE clock update, wherein
   the UE clock update is applied at the reference time information reception, if PD change is not detected after the TA command reception and before the reference time information reception, and
   if the PD change is detected and an updated TA command is not received after the TA command reception and before the reference time information reception, the UE clock update is applied when the updated TA command is received.

(Supplementary note 2)

The method as claimed in Supplementary note 1, further comprising:
applying the UE clock update with T_Ref+PD+delta; where the delta is difference between UE clock value at the UE clock update and the UE clock value at the reference time information reception.

(Supplementary note 3)

The method as claimed in Supplementary note 1, wherein:
the PD computed is equal to half of TA value.

(Supplementary note 4)

The method as claimed in Supplementary note 1, wherein:
detecting the PD change, when there is a change in the PD due to beam change or path change, and the PD change is computed as difference between UE DL timing at the beam change or the path change and the UE DL timing at the TA command reception.

(Supplementary note 5)

A user equipment, UE, comprising:
at least one transceiver; and
at least one processor;
wherein the processor is configured to:
receive, from a (R)AN node, a reference time information (T_Ref);
receive, a Timing Advance (TA) command from the (R)AN node;
compute, Propagation Delay (PD) from the TA command; and
apply, UE clock update, wherein
   the UE clock update is performed at the reference time information reception if the UE did not detect PD change after the TA command reception and before the reference time information reception;
   if the UE detect the PD change and an updated TA command is not received after the TA command reception and before the reference time information reception, the UE clock update is performed when the updated TA command is received.

(Supplementary note 6)

The UE according to Supplementary note 5, further comprising:
the UE clock update is performed with T_Ref+PD+delta; where the delta is difference between UE clock value at the UE clock update and the UE clock value at the reference time information reception.

(Supplementary note 7)

The UE according to Supplementary note 5, wherein
the processor is configured to:
compute the PD as half of TA value.

(Supplementary note 8)

The UE according to Supplementary note 5, wherein
the processor is configured to:
detect the PD change, when there is a change in the PD due to beam change or path change, and the PD change is computed as difference between UE DL timing at the beam change or the path change and the UE DL timing at the TA command reception.

This application is based upon and claims the benefit of priority from India Patent Application No. 202111002014, filed on Jan. 15, 2021, the disclosure of which is incorporated herein in its entirety by reference.

### Abbreviations

For the purposes of the present document, the abbreviations given in 3GPP TR 21.905 [1] and the following apply. An abbreviation defined in the present document takes precedence over the definition of the same abbreviation, if any, in 3GPP TR 21.905 [1].
5GC 5G Core Network
5GS 5G System
5QI 5G QoS Identifier
AMF Access and Mobility Management Function
AS Access Stratum
ASN1 Abstract Syntax Notation One
BWP Bandwidth Part
CORESET COntrol REsource SET
CP Cyclic Prefix
CSI Channel State Information
CSI-RS Channel State Information-Reference Signals
DL Downlink
IIOT Industrial Internet of Things
MAC Medium Access Control
MAC CE MAC Control Element
NG-RAN Next Generation Radio Access Network
NR New Radio/NR radio access
PBCH Physical Broadcast Channel
PD Propagation delay
PDC Propagation delay compensation
PDCCH Physical Downlink Control Channel
PDSCH Physical Downlink Shared Channel
PUCCH Physical Uplink Control Channel
PUSCH Physical Uplink Shared Channel
QCL Quasi Co Location
(R)AN (Radio) Access Network
RRC Radio Resource Control
RS Reference Signal
SA NR Standalone NR
SIB System Information Block
SCS Sub Carrier Spacing
SR Scheduling Request
SRS Sounding Reference Signal
SS Synchronization Signal
SSB SS/PBCH Block
TA Timing advance
TCI Transmission Configuration Indication
UL Uplink
OS Operating System
MO Mobile Originated
MT Mobile Terminated
USIM Universal Subscriber Identity Module

### Definitions

For the purposes of the present document, the terms and definitions given in 3GPP TR 21.905 [1] and the following apply. A term defined in the present document takes precedence over the definition of the same term, if any, in 3GPP TR 21.905 [1].

### LIST OF REFERENCES

[1] 3GPP TR 21.905: “Vocabulary for 3GPP Specifications”. V15.0.0 (2018-03).
[2] 3GPP TS 38.331: “Radio Resource Control (RRC) protocol specification” V15.7.0.
[3] 3GPP TS 38.133: “Requirements for support of radio resource management”
[4] 3GPP TS 38.211: “Physical channels and modulation” V15.7.0
[5] 3GPP TS 38.212: “Multiplexing and channel coding” V15.7.0
[6] 3GPP TS 38.213: “Physical layer procedures for control” V15.7.0
[7] 3GPP TS 38.214: “Physical layer procedures for data” V15.7.0
[8] 3GPP TS 38.321: “Medium Access Control (MAC) protocol specification” V15.7.0
[9] 5G NR: “The next generation wireless technology” Eric Dahlman, Stefan Parkvall, Johan Skold
[10] EP2829099A1 Transmission point selection

### REFERENCE SIGNS LIST

401 Reference time information by (R)AN node or gNB
402 SRS transmission by UE
403 TA command by (R)AN node or gNB
404 UE clock update
601 Reference time information by (R)AN node or gNB
602 Scheduling request by UE
603 TA command by (R)AN node or gNB
604 UE clock update
801 TA command by (R)AN node
802 PD computation by UE
803 Reference time information by (R)AN node or gNB
804 UE clock update

What is claimed is:

1. A method implemented in a User Equipment (UE) for maintaining less than 1 microsecond synchronicity between Time-Sensitive Networking Grand Mater (TSN GM) clock and a UE clock, the method comprising:
receiving a reference time information (T_Ref) from a (R)AN node;
receiving a Timing Advance (TA) command from the (R)AN node;
computing Propagation Delay (PD) from the TA command; and
applying UE clock update, wherein
the UE clock update is applied at the reference time information reception if PD change is not detected after the TA command reception and before the reference time information reception, and
if the PD change is detected and an updated TA command is not received after the TA command reception and before the reference time information reception, the UE clock update is applied when the updated TA command is received.

2. The method as claimed in claim 1, further comprising:
applying the UE clock update with T_Ref+PD+delta; where the delta is difference between UE clock value at the UE clock update and the UE clock value at the reference time information reception.

3. The method as claimed in claim 1, wherein:
the PD computed is equal to half of TA value.

4. The method as claimed in claim 1, wherein:
detecting the PD change, when there is a change in the PD due to beam change or path change, and the PD change is computed as difference between UE DL timing at the beam change or the path change and the UE DL timing at the TA command reception.

5. A user equipment, UE, comprising:
at least one transceiver; and
at least one processor;
wherein the processor is configured to:
receive, from a (R)AN node, a reference time information (T_Ref);
receive, a Timing Advance (TA) command from the (R)AN node;
compute, Propagation Delay (PD) from the TA command; and
apply, UE clock update, wherein
the UE clock update is performed at the reference time information reception if the UE did not detect PD change after the TA command reception and before the reference time information reception;
if the UE detect the PD change and an updated TA command is not received after the TA command reception and before the reference time information reception, the UE clock update is performed when the updated TA command is received.

6. The UE according to claim 5, wherein
the UE clock update is performed with T_Ref+PD+delta; where the delta is difference between UE clock value at the UE clock update and the UE clock value at the reference time information reception.

7. The UE according to claim 5, wherein
the processor is configured to:
compute the PD as half of TA value.

8. The UE according to claim 5, wherein
the processor is configured to:
detect the PD change, when there is a change in the PD due to beam change or path change, and the PD change is computed as difference between UE DL timing at the beam change or the path change and the UE DL timing at the TA command reception.
